(19) United States
(12) Patent Application Publication
(10) Pub. No.: US 2009/0190864 A1
(43) Pub. Date: Jul. 30, 2009

(54) AIRTIGHT EVACUABLE STORAGE BAG AND RELATED METHOD OF MANUFACTURE

(75) Inventors: Martin Calvo, Chula Vista, CA (US); Linh Pham, Chula Vista, CA (US)

Correspondence Address: OSTRAGER CHONG FLAHERTY & BROITMAN PC, 570 LEXINGTON AVENUE, FLOOR 17, NEW YORK, NY, 10022-6894, US

(73) Assignee: ILLINOIS TOOL WORKS INC., Glenview, IL (US)

(21) Appl. No.: 12/361,334

(22) Filed: Jan. 28, 2009

Related U.S. Application Data
(60) Provisional application No. 61/024,664, filed on Jan. 30, 2008.

(51) Int. Cl. B65D 30/10; B65D 33/02; B32B 37/04; B65D 30/08

(52) U.S. Cl. 383/97; 156/66; 156/209; 383/113

(57) ABSTRACT

Methods for manufacturing airtight storage containers (e.g., bags or pouches) made from thermoplastic web material and having heat-sealed margins along a perimeter. To ensure that the storage containers are airtight, an unheated rib is pressed along each heat seal while the web material in the region of each heat seal is still in a softened and pliable state. As a result of the pressure applied, the rib deforms the contacted portion of the heat-sealed web material, leaving an indentation upon cooling of the web material that serves as an air leakage barrier. This air leakage barrier ensures that any air leakage pathway across the heat seal region is closed.

### RELATED PATENT APPLICATION

This application claims the benefit, under Title 35, United States Code, §119(e), of U.S. Provisional Application Ser. No. 61/024,664 filed on Jan. 30, 2008.

### BACKGROUND OF THE INVENTION

This invention generally relates to reclosable bags whose interior volume is hermetically sealed (i.e., airtight) when the bag is closed. In particular, the invention relates to, but is not limited to, evacuable reclosable storage containers or other evacuable reclosable containers.

Collapsible evacuable reclosable storage containers typically include a flexible, airtight bag, an opening through which an article is inserted inside the bag, a zipper for closing the opening and hermetically sealing the bag, and a fixture (e.g., a one-way valve) through which excess air is evacuated from the bag. A user places an article into the bag through the opening, seals the opening, and then evacuates the air in the bag through the fixture. During evacuation, a compressible article contained therein may be significantly compressed so that it is easier to transport and requires substantially less storage space. Other evacuable storage bags use one or more vents rather than a valve for removing air from the interior volume of the storage bag.

Collapsible evacuable reclosable storage containers are beneficial for reasons in addition to those associated with compression of the stored article. For example, removal of the air from the storage container inhibits the growth of destructive organisms, such as moths, silverfish, and bacteria, which require oxygen to survive and propagate. Moreover, such containers, being impervious to moisture, inhibit the growth of mildew.

Not only large, compressible items such as clothing may be stored in a collapsible, evacuable storage container. For example, it may be desirable to store bulk items made of small particles, such as powders or granulated resins, in an evacuated container. One situation that commonly occurs is that a particular bulk item is shipped in a large, rigid container such as a drum. Bulk items may be moisture sensitive and are sealed against moisture during shipment. But many times a user does not need to use the entire contents of the large container, and so once exposed to air the remaining bulk contents quickly become unusable and are thus wasted.

For airtight applications such as compressible reclosable storage bags, it is important to have airtight sealing all around the bag perimeter. A common problem in the heat sealing process is that sometimes, due to insufficient heating or an uneven heat seal surface (by numerous causes), one or more portions of the heated area remain unsealed after the heat sealing process. Wrinkles in the bag making film that propagate across the heat seal line can also give rise to air leakage.

There is a continuing need for improvements in the construction of evacuable reclosable storage containers that can be hermetically sealed. In particular, there is a need for an improved evacuable storage container wherein leakage is eliminated in the areas where the bag edges (e.g., side and/or bottom) are heat sealed.

### BRIEF DESCRIPTION OF THE INVENTION

The present invention is directed to airtight compressible storage containers (e.g., bags or pouches) and methods of manufacturing such products. To ensure that the compressible storage containers are airtight, an unheated rib is pressed along each heat seal while the thermoplastic web material in the region of each heat seal is still in a softened and pliable state. As a result of the pressure applied, the rib deforms the contacted portion of the heat-sealed web material, leaving an indentation upon cooling of the web material that serves as an air leakage barrier. This air leakage barrier ensures that any air leakage pathway across the heat seal region is closed.

One aspect of the invention is a method of manufacture comprising the following steps: (a) arranging web material such that first and second sections thereof oppose each other; (b) after step (a) has been performed, applying heat and pressure in a first zone of the opposed first and second sections of the web material, the heat and pressure being sufficient to soften portions of the web material that lie within the first zone; and (c) after step (b) has been performed, pressing a first rib against the web material in the first zone with sufficient pressure to deform softened web material in the first zone, leaving a first indentation in the web material.

Another aspect of the invention is a reclosable bag comprising: a receptacle having an interior volume and a mouth, and means for closing the mouth, wherein the receptacle comprises first and second panels joined to each other along first and second side seal regions extending transversely from the mouth toward a bottom of the receptacle, the first and second panels being made of thermoplastic material, the first side seal region comprising joined material of the first and second panels that forms a first indentation and the second side seal region comprising joined material of the first and second panels that forms a second indentation, wherein the joined material of each of the first and second indentations serve as respective air leakage barriers.

A further aspect of the invention is a method of manufacture comprising the following steps: (a) arranging web material such that first and second sections thereof are opposed; (b) after step (a) has been performed, pressing a heated sealing bar against a first zone of the opposed first and second sections of the web material, the heat supplied and pressure applied by the heated sealing bar being sufficient to soften portions of the web material that lie within the first zone, the heated sealing bar having a minimum dimension in a width direction; and (c) after step (b) has been performed, pressing a first rib against the web material in the first zone with sufficient pressure to deform softened web material in the first zone, leaving a first indentation in the web material, the first rib having a maximum dimension in the width direction that is less than the minimum dimension in the width direction of the heated sealing bar.

Other aspects of the invention are disclosed and claimed below.

### BRIEF DESCRIPTION OF THE DRAWINGS

FIG. 1 is a drawing showing an isometric view of one conventional type of collapsible, evacuable storage bag.

FIG. 2 is a drawing showing a portion of a conventional reclosable storage bag having thermal side seals.

FIG. 3 is a drawing showing a stage in the manufacture of the reclosable storage bag depicted in FIG. 2.

FIG. 4 is a drawing showing a cross-sectional view of a known zipper suitable for use with a bag of the type depicted in FIG. 1.

FIG. 5 is a drawing showing a view of a portion of an airtight compressible reclosable storage bag in accordance with one embodiment of the invention.

FIG. 6 is a drawing showing an isometric view of various stations in a machine set up to perform operations in a predetermined sequence in accordance with one method of manufacture.

FIG. 7 is a drawing showing an end view of a cross sealing bar with ribs in accordance with one embodiment of the invention.

FIG. 8 is a drawing showing a plan view of an airtight compressible reclosable storage bag in accordance with another embodiment of the invention. Side and bottom heat seals are indicated by hatching.

Reference will now be made to the drawings in which similar elements in different drawings bear the same reference numerals.

### DETAILED DESCRIPTION OF THE INVENTION

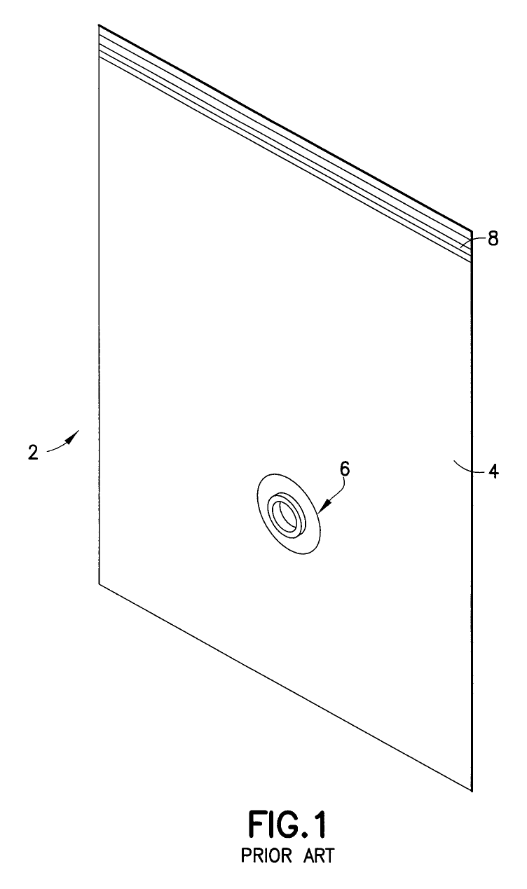

FIG. 1 shows a conventional collapsible, evacuable storage bag 2 comprising a receptacle 4, a valve assembly 6, and a zipper 8 comprising a pair of mutually interlockable extruded zipper strips that are joined to each other at opposing ends thereof. Although not shown in FIG. 1, the conventional valve assembly 6 also typically comprises a cap that can be snapped onto a portion of the valve assembly that is disposed on the exterior of the receptacle 4. The cap must be removed before the receptacle can be evacuated, and then is replaced after the receptacle has been evacuated. The cap is intended to seal the valve assembly to prevent air from entering the evacuated receptacle.

The receptacle 4 typically comprises front and rear walls or panels (typically made of thermoplastic film material) that are joined together at the bottom and two sides by conduction heat sealing to form a receptacle having an interior volume and a mouth in which the zipper 8 is installed. One wall of receptacle 4 has a hole (not shown in FIG. 1) in which to install the valve assembly 6. Alternatively, the receptacle 4 may be made from a web of film that is folded, the fold forming the bottom of the receptacle. The receptacle may optionally be constructed with gussets. The receptacle may be made of a blended extrusion layer of polyethylene sandwiched between a nylon layer and a layer of polyethylene sheeting. However, the materials comprising the receptacle may be altered so as to prevent interaction with the contents stored therein.

During use, one or more discrete articles or a bulk material (not shown) may be placed inside the receptacle 4 while the zipper 8 is open, i.e., while the closure profiles of the interlockable zipper strips are disengaged from each other. After the article or material to be stored has been placed inside the receptacle, the mouth of the receptacle 4 can be sealed by pressing the zipper strips together to cause their respective closure profiles to interlock with each other. Although the zipper closure profiles may have many different designs, the design must be one that ensures formation of an airtight seal at the receptacle mouth.

The zipper strips can be pressed together using a device (not shown in FIG. 1) commonly referred to as a “slider” or “clip”, which straddles the zipper. The typical slider has a generally U-shaped profile, with respective legs disposed on opposing sides of the zipper. The gap between the slider legs is small enough that the zipper can pass through the slider gap only if the zipper is in a closed state. Thus when the slider is moved along an open zipper, this has the effect of pressing the incoming sections of the zipper strips together. The zipper is opened by pulling apart the zipper upper flanges, as explained in more detail below. The slider can be made using any desired method, such as injection molding. The slider can be molded from any suitable plastic, such as nylon, polypropylene, polystyrene, acetal, polyketone, polybutylene terephthalate, high-density polyethylene, polycarbonate, or ABS.

The zipper 8 is designed to form a hermetic seal at the mouth of the receptacle 4 when the zipper 8 closed. After the zipper has been closed, the interior volume of the receptacle can be evacuated by sucking air out via the one-way valve assembly 6. Air can be drawn out of receptacle 4 through valve assembly 6 using a conventional vacuum source, such as a household or industrial vacuum cleaner. The valve assembly 6 and the zipper 8 maintain the vacuum inside receptacle 4 after the vacuum source is removed.

The front and rear wall panels of the receptacle 4 are respectively sealed to the zipper strip by lengthwise conduction heat sealing in conventional manner. Alternatively, the interlockable zipper strips can be attached to the wall panels by adhesive or bonding strips or the zipper profiles can be extruded integrally with the web material. The walls of the receptacle may be formed of various types of gas-impermeable thermoplastic web material. The preferred gas-impermeable thermoplastics are nylon, polyester, polyvinyl dichloride and ethylene vinyl alcohol. The web material may be either transparent or opaque.

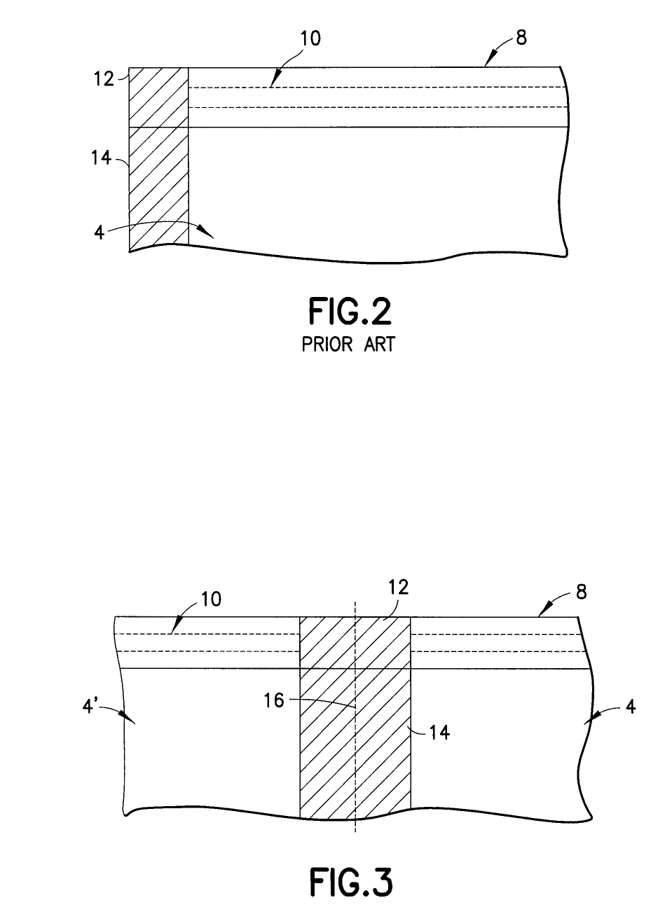

In many reclosable bags, the zipper comprises a pair of mutually interlockable zipper strips, each zipper strip having a respective generally constant profile along the interlockable portion of the zipper. Each zipper strip further comprises upper and lower flanges that extend from the respective closure profile in opposite direction. Each flange is a thin web of the same material used to make the closure profiles. The upper flanges serve as pull flanges that can be gripped and pulled apart to open the zipper. Typically, the ends of the zipper strips are joined together at the sides of the bag. A representative zipper joint is shown in FIG. 2, which depicts one corner of such a reclosable bag. The dashed lines denote a central portion 10 of the zipper 8 comprising interlockable closure profiles, each closure profile comprising a respective plurality of profiled closure elements. The ends of the zipper strips are fused together in area 12 at the same time that the container side seals 14 are formed. If the bag walls extend upward and above the upper zipper flanges, then the side seals typically extend upward as far as the top edges of such upstanding panels. The side seals are typically formed by applying heat and pressure in amounts sufficient to fuse and flatten the closure profiles at the ends of the zipper, which process is often called “thermal crushing”.

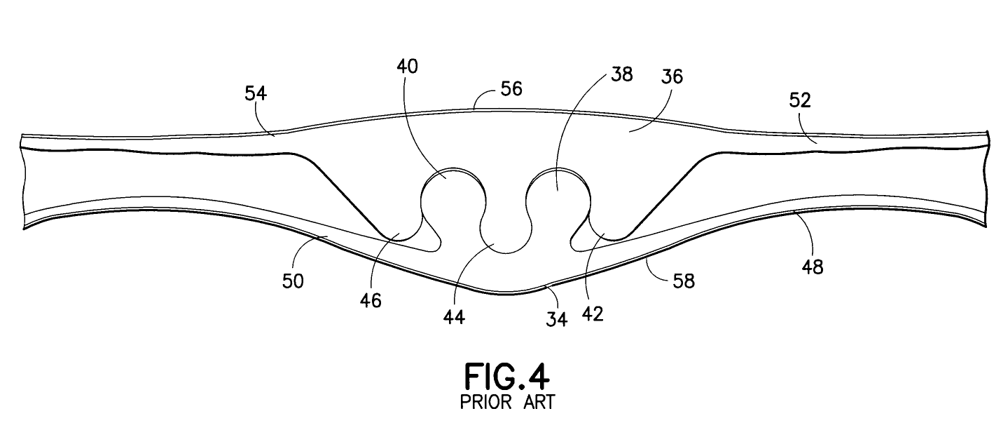

During manufacture, the cross seals are made wide enough so that respective halves of the heat sealed area 14 can be incorporated into two bags, as seen in FIG. 3. The cross-sealed area 14 is bisected by cutting along a line 16 transverse to the zipper 8. The area to the right of the cut line 16 forms the trailing cross seal of the leading receptacle 4 (assuming advancement of the chain of receptacles from left to right in FIG. 3), while the area to the left of the cut line 16 forms the leading cross seal of the trailing receptacle 4′.

To maintain a vacuum inside the storage bag, the zipper in a closed state must provide a hermetic seal at the mouth (i.e., fourth side) of the bag. The present invention is not directed to any particular zipper construction. For the sake of illustration, however, a suitable zipper for use with the present invention will now be described with reference to FIG. 4.

FIG. 4 shows a conventional zipper 8 that comprises a pair of mutually interlockable extruded zipper strips 34 and 36. The zipper strip 34 comprises a pair of projections 38 and 40 having ball-shaped closure profiles, an upper flange 48, and a lower flange 50. The zipper strip 36 comprises three projections 42, 44 and 46 (projection 44 has a ball-shaped closure profile), an upper flange 52, and a lower flange 54. For each zipper strip, the portions exclusive of the projections will be referred to herein as a “base”. The bag walls 56 and 58 may be joined to the respective bases of the zipper strips by conduction heat sealing across their entire height or across only portions thereof. For example, the bag walls could be joined to the zipper lower flanges and to the upper flanges by means of conduction heat sealing.

Still referring to FIG. 4, the projections 38 and 40 interlock with projections 42, 44 and 46 by fitting inside the respective spaces therebetween. The upper flanges 48 and 52 can be gripped by the user and pulled apart to open the closed zipper. The opened zipper can be reclosed by pressing the zipper strips together (e.g., using a slider) along the entire length of the zipper with sufficient force to cause the projections 38 and 40 to enter the respective spaces between the projections 42, 44 and 46. Typically, such a slider takes the form of a U-shaped clip that fits over the zipper with clearance for the upper flanges, while the legs of the clip cam the zipper profiles of the incoming zipper section into engagement when the slider is moved along the zipper in either direction. The opposing ends of the zipper strips 34 and 36 are typically fused together in the regions of the bag side seals, as previously described.

An evacuable storage bag may be constructed from two panels of film joined together (e.g., by conduction heat sealing) along three sides of a rectangle. Alternatively, the bag may be constructed by folding a web of film and heat sealing the confronting sides of the folded web in two side seal regions.

It is important to have airtight sealing all around the bag perimeter in order to maintain the vacuum inside the evacuated bag. A common problem in heat sealing marginal portions of the front and rear panels during bag manufacture is that sometimes due to insufficient heating or an uneven heat seal surface (by numerous causes), one or more portions of the heated area remain unsealed after the heat sealing process. Wrinkles in the bag making film that propagate across the heat seal line can also give rise to air leakage.

In accordance with the embodiments disclosed herein, to ensure that the evacuated storage bag is airtight, an unheated rib is pressed along each heat seal while the thermoplastic web material in the region of each heat seal is still in a softened state following the initial cross sealing operation. As a result of the pressure applied, the rib deforms the contacted portion of the heat-sealed web material, leaving an indentation that serves as an air leakage barrier. This air leakage barrier ensures that any air leakage pathway across the heat seal region is closed.

In accordance with one embodiment, a pair of spaced apart and parallel ribs are pressed against the heat sealed region, which is still in a softened and pliable state, thereby forming a pair of spaced-apart and parallel indentations. FIG. 5 shows a portion of a storage bag made using this technique. A side heat seal, formed along a margin of the receptacle 4, is generally indicated by reference numeral 80. A pair of indentations 82 and 84 are formed in the heat-sealed region 80. These indentations extend generally parallel to the edge 86 of the bag. More specifically, the side seal region 80 along the margin comprises joined material (of the front and rear panels of receptacle 4) forming indentations 82 and 84, the continuous joined material of each indentation functioning as an air leakage barrier. The side seal region on the other side of the receptacle 4 (not shown in FIG. 5) has a similar construction.

Each indentation in a side seal region creates an obstacle to air leaking through any air leakage channel that may be present in that side seal region. Additional pressure/stress is created on the seal at the localized areas where the ribs contact the seal so that at least heat sealing is ensured in those localized areas. The intended effect is to provide an additional barrier to prevent the vacuum inside the receptacle from being lost in the event that any areas of the side seal may not be sealed all the way through. The pressure applied using an unheated ribbed cross sealing bar eliminates or greatly reduces the risk of air leakage through the side seals.

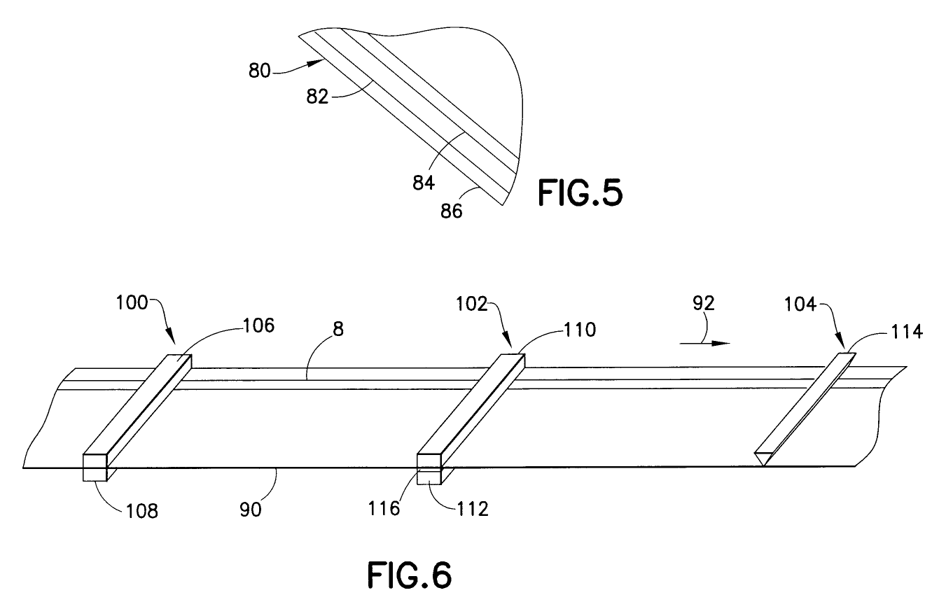

Compressible reclosable storage bags of the type shown in FIG. 5 can be manufactured on an automated production line, some stations of which are depicted in FIG. 6. In accordance with one automated method of manufacture, two webs of film are paid off respective rolls (not shown) and brought into overlying relationship. Downstream respective sets of pull rollers (not shown) are provided for pulling the webs through the bag making machine. A continuous length of interlocked zipper strips is paid off a spool (not shown) and fed between the advancing film webs. Typically the webs and the zipper are advanced intermittently, while certain operations are performed during the dwell times. At a first sealing station (not shown), marginal portions of opposing sections of each web are sealed to the backs of opposing sections of the respective zipper strips by a first pair of sealing bars (not shown), at least one of which is heated. At the same or at a different station, marginal portions of opposing sections of each web are heat sealed together by a second pair of sealing bars to form a bottom seal. At an ultrasonic welding station (not shown), the zipper is stomped at package-length intervals, while a respective slider is inserted onto each unstomped section of zipper by a conventional slider insertion device (not shown).

At a sealing station 100 (see FIG. 6), a cross seal is formed by conduction heat sealing. Sealing station 100 comprises a pair of opposing sealing bars 106 and 108, at least one of which is heated. The web material 90 passes between the opposing sealing bars 106 and 108. Preferably the heated sealing bar has a heat-conductive planar surface that contacts the bag film, applying pressure and heat to form a cross seal of the type partially depicted in FIG. 3 (see hatched region 14). After cross sealing, the webs of bag film are again advanced by one package length, so that the newly formed cross seal arrives at the next station 102. The direction of advancement is indicated by arrow 92. A person skilled in the art will readily appreciate that the cross sealing operation could be performed either before or after bottom sealing.

Still referring to FIG. 6, station 102 comprises an unheated ribbed sealing bar 110 opposed by a backup bar 112 having a layer 116 of elastomeric material (e.g., silicone rubber) on a surface opposing the ribbed sealing bar 110. During the dwell time, one or both bars 110 and 112 are moved toward the other, pressing the web material 90 therebetween. During this operation, the web material in the cross seal region (e.g., region 14 seen in FIG. 3) is still in a softened and pliable state, which softened material deforms when contacted by the ribs on the ribbed sealing bar 110 to form corresponding indentations of the type seen in FIG. 5. The ribbed sealing bar is not heated and may be at room temperature. Alternatively, means for cooling or chilling the ribbed sealing bar could be provided.

Thereafter the webs of bag film are again advanced by one package length, so that the indented cross seal arrives at a cutting station 104. The cutting station 104 comprises a knife 114 that is used to sever individual bags from one another by cutting along a line that bisects the cross seal (e.g., see line 16 in FIG. 3), thereby forming respective side seals on the separated bags.

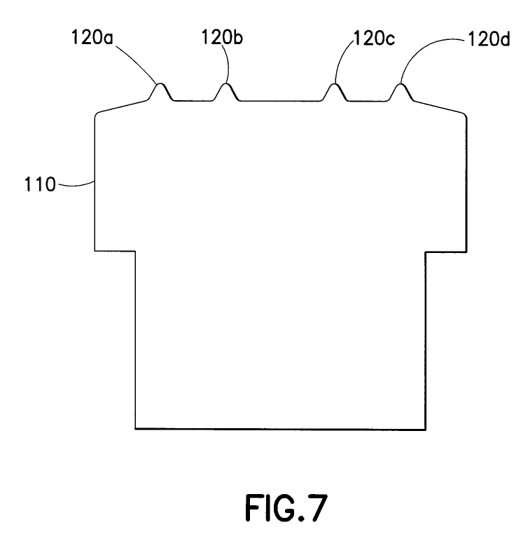

The profile of the ribbed cross sealing bar 110 is shown in the end view of FIG. 7. The bar is preferably made from cold rolled steel. The ribbed surface in this embodiment has four ribs 120a-120d projecting therefrom, each rib having a profile that is rounded at the tip. The angled sides of each rib are preferably separated by a 60° angle. Each rib is straight and extends the full length of the bar. The four ribs are mutually parallel and spaced apart. During the process depicted in FIG. 6, ribs 120a and 120b will form indentations in a portion of the web material that will become the right-hand side seal region of one bag, while ribs 120c and 120d will form indentations in a portion of the web material that will become the left-hand side seal region of another bag, both bags being connected at station 102, but being severed at cutting station 104. The cut will be made midway between the indentations formed by ribs 120b and 120c.

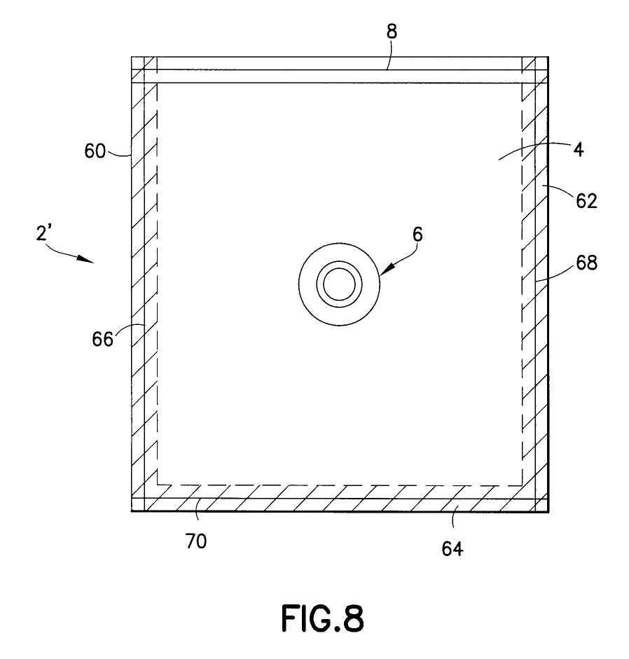

FIG. 8 is a plan view showing an airtight compressible reclosable storage bag 2′ having side seals 60 and 62 and a bottom seal 64, all formed using heated sealing bars. For the machine partly depicted in FIG. 6, the sealing bar for forming the bottom seal 64 would be disposed orthogonal to the sealing bars 106 and 108. The lines 66 and 68 represent indentations formed using an unheated ribbed sealing bar. Although only one indentation is shown in each side seal region, a person of ordinary skill in the art would readily appreciate that each side seal region could be provided with one indentation or multiple parallel indentations (as seen in FIG. 5). Likewise the bottom seal 64 can be provided with a single indentation 70, as shown in FIG. 8, or multiple parallel indentations, thereby forming one or more air leakage barrier lines in the bottom seal. To accomplish the foregoing, it should be appreciated that a second unheated ribbed sealing bar would need to be installed on the machine partly depicted in FIG. 6, the second unheated ribbed sealing bar being disposed orthogonal to the unheated ribbed sealing bar 110 and being opposed by its own backup bar with elastomeric layer on its confronting surface. The number of ribs on the second ribbed sealing bar would be equal to the number of indentations, i.e., air leakage barrier lines, desired.

A person skilled in the art would appreciate that the bags could be formed from a single web that is folded and cross sealed, instead of from two webs that are bottom sealed and then cross sealed together. Also the zipper strips could be joined to the respective webs separately and then interlocked before ultrasonic welding of the zipper joints. Finally, the disclosed invention has application on any evacuable reclosable compressible storage bag regardless of the means by which the bag is to be evacuated. For example, instead of providing the storage bag with a one-way valve assembly, the bag could be provided with one or more one-way valves in the form of vent strips, e.g., of the type disclosed in U.S. Pat. No. 6,729,473.

While embodiments have been disclosed herein with reference to reclosable storage containers, the method of forming air leakage barriers disclosed and claimed herein also has application in the manufacture of airtight storage containers that do not incorporate reclosable means such as a plastic zipper.

While the invention has been described with reference to various embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the verb “joined” means fused, welded, bonded, sealed, adhered, etc., whether by application of heat and/or pressure, application of ultrasonic energy, application of a layer of adhesive material or bonding agent, interposition of an adhesive or bonding strip, co-extrusion (e.g., of zipper and bag), etc.

1. A method of manufacture comprising the following steps:
(a) arranging web material such that first and second sections thereof oppose each other;
(b) after step (a) has been performed, applying heat and pressure in a first zone of said opposed first and second sections of said web material, the heat and pressure being sufficient to soften portions of said web material that lie within said first zone; and
(c) after step (b) has been performed, pressing a first rib against said web material in said first zone with sufficient pressure to deform softened web material in said first zone, leaving a first indentation in said web material.

2. The method as recited in claim 1, further comprising the step of joining first and second zipper strips of a plastic zipper to said web material prior to step (b), said first zipper strip comprising a first closure profile and said second zipper strip comprising a second closure profile, said first and second closure profiles being interengageable;

3. The method as recited in claim 1, wherein said first rib has a maximum width less than a minimum width of said first zone.

4. The method as recited in claim 1, further comprising the step, performed after step (c) has been performed, of cutting said web material along a first cut line that intersects said first zone, wherein said first rib and said first cut line are straight, and said first indentation and said first cut line are spaced apart and parallel.

5. The method as recited in claim 1, wherein said pressed web material is supported by elastomeric material during step (c).

6. The method as recited in claim 1, further comprising the following steps:
(d) after step (b) has been performed, applying heat and pressure in a second zone of said opposed first and second sections of said web material, the heat and pressure being sufficient to soften portions of said web material that lie within said second zone; and
(e) after step (d) has been performed, pressing a second rib against said web material in said second zone with sufficient pressure to deform softened web material in said second zone, leaving a second indentation in said web material.

7. The method as recited in claim 6, further comprising the following steps:
(f) after step (c) has been performed, cutting said web material along a first cut line that intersects said first zone; and
(g) after step (e) has been performed, cutting said web material along a second cut line that intersects said second zone,
wherein said first cut line and said first indentation are straight and parallel and said second cut line and said second indentation are straight and parallel when said first and second sections of web material are planar, said first and second indentations being disposed between said first and second cut lines.

8. The method as recited in claim 1, wherein step (c) further comprises pressing a second rib against said web material in said first zone with sufficient pressure to deform softened web material in said first zone, leaving a second indentation in said web material, said first and second indentations being spaced apart and parallel.

9. A reclosable bag comprising: a receptacle having an interior volume and a mouth, and means for closing said mouth, wherein said receptacle comprises first and second panels joined to each other along first and second side seal regions extending transversely from said mouth toward a bottom of said receptacle, said first and second panels being made of thermoplastic material, said first side seal region comprising joined material of said first and second panels that forms a first indentation and said second side seal region comprising joined material of said first and second panels that forms a second indentation, wherein said first and second indentations serve as respective air leakage barriers.

10. The bag as recited in claim 9, wherein said mouth closing means comprise a flexible zipper comprising first and second zipper strips respectively joined to said first and second panels in the area of said mouth, said first zipper strip comprising a first closure profile and said second zipper strip comprising a second closure profile, said first and second closure profiles being interengageable.

11. The bag as recited in claim 9, wherein said first and second panels are also joined to each other along a bottom seal region extending along said bottom of said receptacle, said bottom side seal region comprising joined material of said first and second panels that is disposed along a bottom of a third indentation that intersects said first and second indentations.

12. The bag as recited in claim 9, wherein said first side seal region further comprises joined material of said first and second panels that is disposed along a bottom of a third indentation spaced apart from and parallel to said first indentation, and said second side seal region comprises joined material of said first and second panels that is disposed along a bottom of a fourth indentation spaced apart from and parallel to said second indentation, wherein said joined material of each of said third and fourth indentations forms an air leakage barrier.

13. A method of manufacture comprising the following steps:
(a) arranging web material such that first and second sections thereof are opposed;
(b) after step (a) has been performed, pressing a heated sealing bar against a first zone of said opposed first and second sections of said web material, the heat supplied and pressure applied by said heated sealing bar being sufficient to soften portions of said web material that lie within said first zone, said heated sealing bar having a minimum dimension in a width direction; and
(c) after step (b) has been performed, pressing a first rib against said web material in said first zone with sufficient pressure to deform softened web material in said first zone, leaving a first indentation in said web material, said first rib having a maximum dimension in said width direction that is less than said minimum dimension in said width direction of said heated sealing bar.

14. The method as recited in claim 13, further comprising the step of joining first and second zipper strips of a plastic zipper to said web material prior to step (b), said first zipper strip comprising a first closure profile and said second zipper strip comprising a second closure profile, said first and second closure profiles being interengageable;

15. The method as recited in claim 13, wherein said first rib has a rounded tip.

16. The method as recited in claim 13, further comprising the step, performed after step (c) has been performed, of cutting said web material along a first cut line that intersects said first zone, wherein said first rib and said first cut line are straight, and said first indentation and said first cut line are spaced apart and parallel.

17. The method as recited in claim 13, wherein said pressed web material is supported by elastomeric material during step (c).

18. The method as recited in claim 13, further comprising the following steps:
(d) after step (b) has been performed, pressing said heated sealing bar against a second zone of said opposed first and second sections of said web material, the heat supplied and pressure applied by said heated sealing bar being sufficient to soften portions of said web material that lie within said second zone, said heated sealing bar having a minimum dimension in a width direction; and
(e) after step (d) has been performed, pressing a second rib against said web material in said second zone with sufficient pressure to deform softened web material in said second zone, leaving a second indentation in said web material.

19 The method as recited in claim 18, further comprising the following steps:
(f) after step (c) has been performed, cutting said web material along a first cut line that intersects said first zone; and
(g) after step (f) has been performed, cutting said web material along a second cut line that intersects said second zone,
wherein said first cut line and said first indentation are straight and parallel and said second cut line and said second indentation are straight and parallel when said first and second sections of web material are planar, said first and second indentations being disposed between said first and second cut lines.

20. The method as recited in claim 13, wherein step (c) further comprises pressing a second rib against said web material in said first zone with sufficient pressure to deform softened web material in said first zone, leaving a second indentation in said web material, said first and second indentations being spaced apart and parallel.
